(19) United States
(12) Patent Application Publication
(10) Pub. No.: US 2014/0312008 A1
(43) Pub. Date: Oct. 23, 2014

(54) DRAWN ARC STUD WELDING SYSTEM

(71) Applicants: David P. WORKMAN, Dublin, OH (US); Seth C. Shira, Cardington, OH (US)

(72) Inventors: David P. WORKMAN, Dublin, OH (US); Seth C. Shira, Cardington, OH (US)

(21) Appl. No.: 14/257,587

(22) Filed: Apr. 21, 2014

Related U.S. Application Data
(60) Provisional application No. 61/814,500, filed on Apr. 22, 2013.

(51) Int. Cl. B23K 9/20

(52) U.S. Cl. CPC B23K 9/20; B23K 9/208
USPC 219/99; 219/98

(57) ABSTRACT

A system for drawn arc stud welding that includes a drawn arc stud welding device; a substrate; a stud for attachment to the substrate; a modified ferrule; and modified flux. The ferrule is placed around the stud in the welding device prior to attaching the stud to the substrate and further includes a ferrule body having inner and outer surfaces and top and bottom surfaces. The ferrule body has been modified to include tapered inner walls, smoothed inner surfaces, beveled inner surfaces, notched bottom surfaces, or combinations thereof. The flux has been bound to or integrated with the inner surfaces and bottom surfaces of the ferrule body and has been modified to have a particle size of less than about 1200 μm. The flux is placed outside of the arc path generated by the stud welding device.

### CROSS-REFERENCE TO RELATED APPLICATIONS

This patent application claims the benefit of U.S. Provisional Patent Application Ser. No. 61/814,500 filed on Apr. 22, 2013 and entitled “Improved Drawn Arc Stud Welding”, the disclosure of which is hereby incorporated by reference herein in its entirety and made part of the present U.S. utility patent application for all purposes.

### BACKGROUND OF THE INVENTION

The described invention relates in general to welding systems and processes, and more specifically to a system and method for drawn arc stud welding wherein the metal flow during welding, fatigue resistance, and aesthetic qualities of the final weldment are improved and/or enhanced. Additionally, the welding current required to weld studs of equal size is significantly reduced (e.g., by approximately 30%) due the improved efficiency in the process.

Drawn arc stud welding is a process that is generally used to weld metal fasteners to metal substrates. The process involves joining a metal stud or appurtenance to a metal substrate by heating both parts with an electrical arc. This process creates strong welds on a metal substrate in very short time periods without disturbing the opposite side of the metal substrate. This process provides a highly reliable method for fastening studs for a wide variety of applications and almost any size or configuration of metal stud can be welded quickly to a substrate. Carbon steel alloys, stainless steel, aluminum, and nickel-based alloys are suitable exemplary materials for drawn arc stud welding.

In addition to the metal stud and metal substrate, the process of drawn arc stud welding typically includes the use of a power supply to create the arc, a stud welding tool or weld gun, and a ferrule. The weld studs typically have a balled tip made of aluminum that is used in aiding the ignition and stabilizing of the arc. These balled tips are often referred to as flux loaded. This tip flux differs from the ferrule flux that is an important part of the invention described herein. The stud is loaded into the welding gun chuck, and a ferrule is placed over the end of the stud. The ferrule is a disposable ceramic shield that contains the molten pool of metal. The actual drawn arc stud welding process involves several steps (see FIG. 1). First, the weld gun is positioned over the metal substrate and the main gun spring is partially compressed. Second, the trigger of the weld gun is pressed and the stud lifts off the substrate, drawing an arc. The arc melts the end of the weld stud and the substrate below. The ferrule shields the arc and concentrates the heat below the weld stud while containing the molten metal within the weld zone. Third, the main spring plunges the weld stud down into the molten pool of metal on the substrate. The cycle is completed in roughly a second and the resulting weld develops the full strength of the fastener in the weld zone. Fourth, the weld gun is withdrawn from the welded stud leaving the ferrule which is then broken away and discarded.

A weld produced by the drawn arc process offers a variety of benefits, including high structural integrity, excellent productivity, leak resistance, corrosion resistance, as well as minimized noise and vibration. The process has extensive use in a wide range of static load applications, including: automotive, construction, highway equipment, institutional apparatuses, furniture, metal products, industrial uses, power generation, shipbuilding, lawn and garden equipment, electrical/electronic devices, and others. However, certain aspects or characteristics of the weldments created by this process can be problematic and undesirable. For example, the weld joints created by the drawn arc process typically leave a significant notch around the outer diameter of the fusion zone. This notch creates a large stress riser that may significantly reduce fatigue performance. Testing on such weldments has shown excellent static strength; however, the endurance limit load was only 2% of the ultimate load in the testing completed. All fatigue failures resulted from propagation of a crack initiating from a notch aro. and the outer diameter of the stud weld, which is often referred to as the fillet of the drawn arc stud weld. Additionally, current welding processes of this nature use high welding currents due to the oxygen or oxygen sources within a standard ferrule. This creates high temperature oxides on the surface of the plate that are difficult to remove and can lead to undercut within the weld itself. In order to eliminate these oxides, a higher welding current is used to melt a larger than required area that is forged out of the joint to cleanse the joint of contaminants, leading to increased costs associated with the process.

Certain known drawn arc stud welding systems utilize double chamber ferrules having a loose powdered flux placed in the outer ferrule chamber for very large diameter drawn arc stud welds. In such systems, an inner chamber contains the weld on the inside diameter of the ferrule and an outer chamber is provided for the loose powdered flux around the outside diameter of the inner ferrule. This approach adds cost, complexity to the set-up, and leaves excess loose powdered flux around the welding site. This system may also involves the placement of a flux rod in the center of partially hollow weld stud which adds further cost and complexity and may affect the final performance of the metal in the joint because the flux rod is added into the weld joint directly. Adding flux directly to the arc path can lead to erratic arc characteristics and slag (re-solidified flux) inclusion in the weld material. Thus, there is an ongoing need for an improved, controllable, low cost method for adding a bound flux to the areas of concern without compromising weld robustness or adding unwanted cost and complexity to the process.

### SUMMARY OF THE INVENTION

The following provides a summary of certain exemplary embodiments of the present invention. This summary is not an extensive overview and is not intended to identify key or critical aspects or elements of the present invention or to delineate its scope.

In accordance with one aspect of the present invention, a ferrule for use in drawn arc stud welding is provided. This ferrule includes a modified ferrule body and a modified welding flux. The ferrule body has inner and outer surfaces and top and bottom surfaces and has been modified to include tapered inner walls, smoothed inner surfaces, beveled inner surfaces, notched bottom surfaces, or combinations thereof. The welding flux has been bound to or integrated with the inner surfaces and bottom surfaces of the ferrule body and has been modified to have a particle size of less than about 1200 μm.

In accordance with another aspect of the present invention, a system for drawn arc stud welding is provided. This system includes a drawn arc stud welding device; a substrate; a stud for attachment to the substrate; a modified ferrule; and modified welding flux. The ferrule is placed around the stud in the welding device prior to attaching the stud to the substrate and further includes a ferrule body having inner and outer surfaces and top and bottom surfaces. The ferrule body has been modified to include tapered inner walls, smoothed inner surfaces, beveled inner surfaces, notched bottom surfaces, or combinations thereof. The welding flux has been bound to or integrated with the inner surfaces and bottom surfaces of the ferrule body and has been modified to have a particle size of less than about 1200 μm. The flux is placed outside of the arc path generated by the stud welding device.

In yet another aspect of this invention, a process for drawn arc stud welding is provided. This process includes providing a drawn arc stud welding gun; providing a substrate; providing a stud for attachment to the substrate; providing a modified ferrule; providing modified welding flux; placing the ferrule around the stud in the welding gun prior to attaching the stud to the substrate; placing the welding gun against the substrate and activating the gun to create a weld between the substrate and the stud; and removing the stud welding gun from the welded stud and discarding the ferrule. The ferrule further includes a ferrule body having inner and outer surfaces and top and bottom surfaces that have been modified to include tapered inner walls, smoothed inner surfaces, beveled inner surfaces, notched bottom surfaces, or combinations thereof. The flux has been bound to or integrated with the inner surfaces and bottom surfaces of the ferrule body and has been modified to have a particle size of less than about 1200 μm. The flux is placed outside of the arc path generated by the welding gun.

Additional features and aspects of the present invention will become apparent to those of ordinary skill in the art upon reading and understanding the following detailed description of the exemplary embodiments. As will be appreciated by the skilled artisan, further embodiments of the invention are possible without departing from the scope and spirit of the invention. Accordingly, the drawings and associated descriptions are to be regarded as illustrative and not restrictive in nature.

### BRIEF DESCRIPTION OF THE DRAWINGS

The accompanying drawings, which are incorporated into and form a part of the specification, schematically illustrate one or more exemplary embodiments of the invention and, together with the general description given above and detailed description given below, serve to explain the principles of the invention, and wherein:

FIG. 1 provides a series of illustrations depicting the generalized process of drawn arc stud welding;

FIG. 2 is a cross-sectional side view of a ferrule in accordance with an exemplary embodiment of the present invention illustrating the beveled inner surface formed near the base thereof;

FIG. 3 is a perspective view of the ferrule of the present invention showing the tapered inner walls, beveled inner surfaces, and notched bottom surfaces thereof;

FIG. 4 illustrates the appearance of the ferrule of the present invention showing beveling and the addition of bound flux to the base and sidewalls of the fillet area;

FIG. 5 is a cross-sectional photographic view of a drawn arc stud weld made with a standard ferrule; and

FIG. 6 is a cross-sectional photographic view of a drawn arc stud weld made with the fluxed ferrule of the present invention.

### DESCRIPTION OF THE INVENTION

Exemplary embodiments of the present invention are now described with reference to the Figures. Although the following detailed description contains many specifics for purposes of illustration, a person of ordinary skill in the art will appreciate that many variations and alterations to the following details are within the scope of the invention. Accordingly, the following embodiments of the invention are set forth without any loss of generality to, and without imposing limitations upon, the claimed invention.

The present invention relates generally to drawn arc stud welding, and more specifically to a system and method for drawn art stud welding wherein the molten weld metal flow, fatigue resistance and aesthetic qualities of the final weldment are improved and/or enhanced. As previously discussed, drawn arc stud welds often suffer from poor tensile fatigue performance. Testing has identified the area at the outer diameter of the fillet as a location of stress concentrations that lead to the initiation of fatigue cracks. These areas suffer from cold lap, undercut (notch), and/or lack of fusion which acts much like a crack tip. When a cyclic loading acts on these features cracks propagate, shortening the fatigue life of the weld joint. The present invention creates a drawn arc stud weld profile that significant reduces the features around the stud and improves the fatigue performance of the weld. This is achieved primarily through the use of a modified ferrule with bound flux added to the weld metal chamber and base. The result is a fillet that is improved both in shape and appearance, as well as in fatigue resistance.

Current practice often involves overwelding drawn arc stud welds with longer times and/or higher electrical currents to use molten iron created in the weld joint as a getter to strip oxides off the periphery of the weld joint. This technique is only partially effective as there still tends to be a cold lap remaining at the edge of the flash created by the process around the joint. Flux is added to the welding process to eliminate the cold lap, eliminate the oxidation of the metal around the joint during welding, and make the process more efficient. This results in a reduction in the required welding current as an overweld condition is no longer required to produce a decent quality weld joint. However, the use of loose powdered flux in drawn arc stud welds does not yield acceptable results. The use of a loose powdered flux inside the ferrule is discouraged in articles due to the formation of an unstable arc when loose powdered flux is present in the arc path. By binding flux having a small particle size to the sides of the ferrule, the adverse effects of loose powder flux being in the arc are eliminated as the flux does not directly interact with the arc itself. Thus, a primary benefit of the present invention is that by binding the flux to the inside of the ferrule, most of the benefits of the flux can be realized without the negative impact that flux has when introduced into the arc itself The use of bound flux permits a reduction in the welding current of approximately 30-35% compared to a normal ferrule without bound flux. This reduction in welding current is made possible by making the welding environment in the ferrule itself favorable for a more efficient transfer of the arc. The bound flux and placement of the bound flux create the conditions that allow this environment to develop during the welding process.

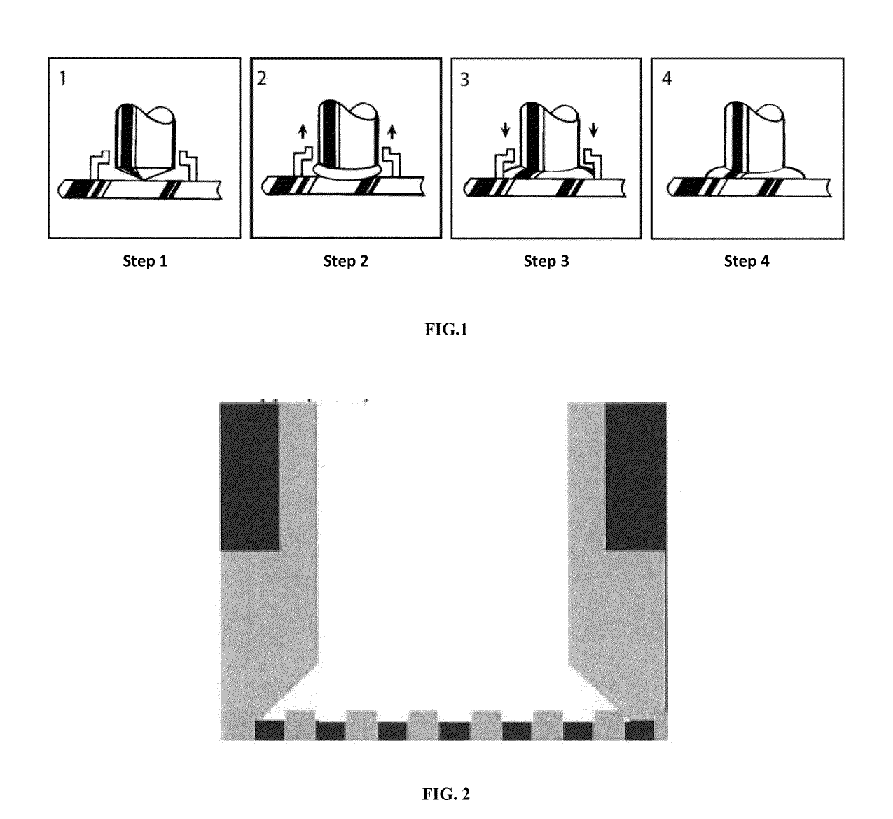

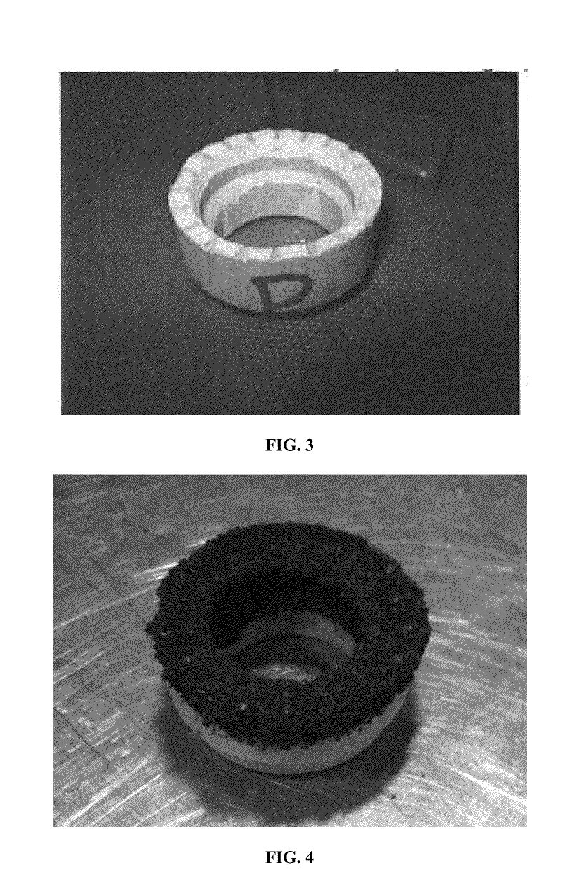

With reference to FIGS. 2-6, the ferrules used with various embodiments of the present invention are typically commercially available ferrules that have been modified to include certain unique features such as smoothed or beveled surfaces and enhanced bottom edges. The ferrule constrains molten weld metal to form the fillet around the weld joint during the welding process and in this invention the ferrule is modified to approximate an even legged fillet with transition angles at the weld/stud transition and weld/substrate transition that minimize sharp corners. Sharp corners or similar geometric features typically affect the fatigue performance of a weld joint. This modification of the ferrule leads to a much improved fatigue design in the weld joint and improves the overall aesthetics of the weld joint. Instead of straight ferrule sidewalls, a tapered sidewall is used to create a smoother transition. Additionally, the taper and base of the ferrule is coated with a bound flux that is located away from the arcing area to avoid detrimental arc interaction. The modified base of the ferrule (see FIG. 4) is heavily coated with bound flux to act on the molten metal at its end point and smooth out the fillet. After welding, bound flux which has become molten during the welding process, forms a glassy ceramic that entraps the oxides and other contaminates in the weld pool on the surface of the ferrule body.

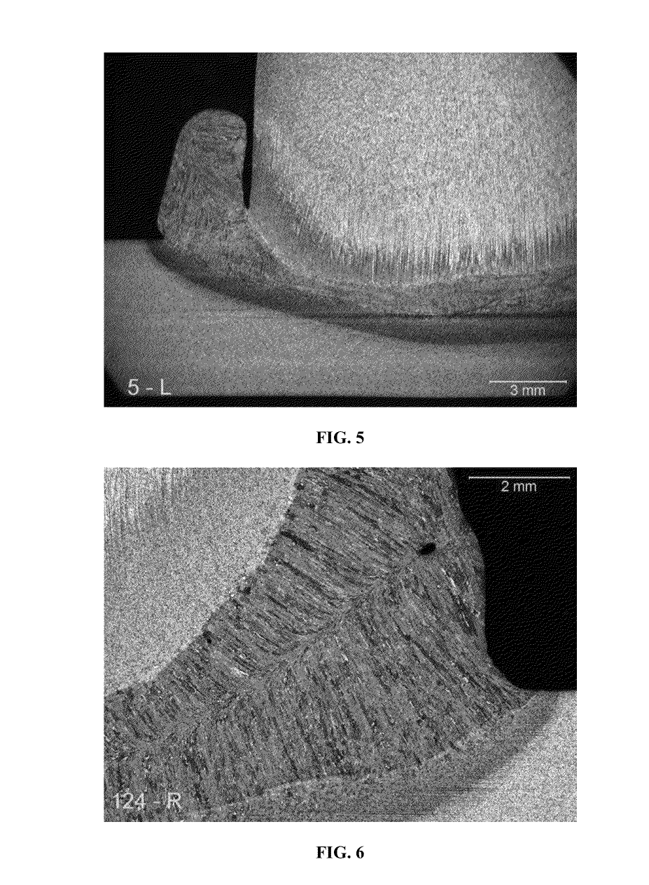

With regard to the bound flux, which the skilled artisan will understand to be an agglomerated, granular, fusible mineral compound or the like, the particle size may be limited to less than about 1200 μm. A small bound flux particle size appears to be critical such that it can be easily bound to the ferrule and quickly react with the arc heat and molten metal to produce a favorable welding environment. The flux is bound to the inner diameter of the ferrule so that it may interact with the molten metal expelled from the weld joint during the welding process. In one embodiment of this invention, the ferrule is coated with a binder such as polyvinyl alcohol (PVA) and then dipped into a pile of flux, thereby allowing the flux to bind to desired regions within the ferrule. The desired regions include the base of the ferrule and the inner diameter of the ferrule where the fillet weld is formed. No bound flux is added to any area of the ferrule where the arc may interact with the flux as it drastically modifies arc characteristics and may result in erratic arc behavior. The bound flux aids in wetting of the molten weld fillet area into the substrate and thus eliminates the cold lap notch typically observed in these welds. In some embodiments, the bound flux is formulated with deoxidizers to further aid in wetting and/or with certain melting point suppressants to aid in tying the fillet into the substrate. The appearance of re-solidified flux (known as slag) on the inner diameter of the ferrule after welding illustrates that the bound flux is activated by the heat generated during the welding process yet remains predominately on the ferrule itself. In welding trials the bound flux coating found most effective for eliminating the cold lap and improving the geometry was Lincoln 761, an agglomerated active flux (see FIGS. 5-6); however, any flux or deoxidizing agent such a carbon blacking, silicon, or other known “getters” may be used with this invention to improve the drawn arc stud welding process.

In another embodiment of this invention, a bound flux with enhanced deoxidizing potential may be added to the inner diameter of the ferrule to aid in create drawn arc stud welds on galvanized materials. Adding flux having this characteristic will aid in the elimination of the zinc coating from the weld joint, thereby preventing liquid metal embrittlement. Adding flux having this characteristic will also reduce or remove zinc vapor from the arc, thereby creating more stable arc characteristics. Enhanced deoxidizing characteristics may be provided by adding a layer of PVA to the inner diameter of the ferrule or by binding a metal oxide which is reduced by the zinc in the thermal cycle, thus tying up the zinc in an oxide form which is expelled from the weld joint as slag. Suitable metal oxides include, for example, iron oxide, and copper oxide, which may be may be mixed with the bound flux to effectively eliminate the galvanizing while still providing an improved weld joint geometry. These metal oxides may be added in various predetermined amounts with the bound flux or in layer to create a weld joint having an improved appearance.

While the present invention has been illustrated by the description of exemplary embodiments thereof, and while the embodiments have been described in certain detail, it is not the intention of the Applicant to restrict or in any way limit the scope of the appended claims to such detail. Additional advantages and modifications will readily appear to those skilled in the art. Therefore, the invention in its broader aspects is not limited to any of the specific details, representative devices and methods, and/or illustrative examples shown and described. Accordingly, departures may be made from such details without departing from the spirit or scope of the applicant's general inventive concept.

What is claimed:

1. A ferrule for use in drawn arc stud welding, comprising:
(a) a ferrule body having inner and outer surfaces and top and bottom surfaces; wherein the ferrule body has been modified to include tapered inner walls, smoothed inner surfaces, beveled inner surfaces, notched bottom surfaces, or combinations thereof; and
(b) flux, wherein the flux has been bound to or integrated with the inner surfaces and bottom surfaces of the ferrule body, and wherein the flux has been modified to have a particle size of less than about 1200 μm.

2. The ferrule of claim 1, wherein predetermined portions of the ferrule body are coated with a binder, and wherein the binder facilitates binding the flux to the ferrule body.

3. The ferrule of claim 1, wherein the flux is an agglomerated, granular, fusible mineral compound.

4. The ferrule of claim 1, wherein the flux is operative to reduce the welding current required to create a drawn arc stud weld.

5. A system for drawn arc stud welding, comprising:
(a) a drawn arc stud welding device;
(b) a substrate;
(c) a stud for attachment to the substrate;
(d) a ferrule, wherein the ferrule is placed around the stud in the welding device prior to attaching the stud to the substrate; wherein the ferrule further includes a ferrule body having inner and outer surfaces and top and bottom surfaces; and wherein the ferrule body has been modified to include tapered inner walls, smoothed inner surfaces, beveled inner surfaces, notched bottom surfaces, or combinations thereof; and
(e) flux, wherein the flux has been bound to or integrated with the inner surfaces and bottom surfaces of the ferrule body, and wherein the flux has been modified to have a particle size of less than about 1200 μm; and wherein the flux has been placed outside of the arc path generated by the stud welding device.

6. The system of claim 5, wherein predetermined portions of the ferrule body are coated with a binder, and wherein the binder facilitates binding the flux to the ferrule body.

7. The system of claim 5, wherein the flux is an agglomerated, granular, fusible mineral compound.

8. The system of claim 5, wherein the flux is operative to reduce the welding current required to create a drawn arc stud weld.

9. The system of claim 5, wherein the modified ferrule and modified flux are operative to enhance the aesthetic appearance of a weldment created with the system; enhance the fatigue resisting characteristics of a weldment created with the system; enhance the weld metal flow characteristics of a weldment created with the system; or combinations thereof.

10. A process for drawn arc stud welding, comprising:
(a) providing a drawn arc stud welding gun;
(b) providing a substrate;
(c) providing a stud for attachment to the substrate;
(d) providing a ferrule, wherein the ferrule further includes a ferrule body having inner and outer surfaces and top and bottom surfaces; and wherein the ferrule body has been modified to include tapered inner walls, smoothed inner surfaces, beveled inner surfaces, notched bottom surfaces, or combinations thereof;
(e) providing flux, wherein the flux has been bound to or integrated with the inner surfaces and bottom surfaces of the ferrule body; wherein the flux has been modified to have a particle size of less than about 1200 μm; and wherein the flux has been placed outside of the arc path generated by the welding gun;
(f) placing the ferrule around the stud in the welding gun prior to attaching the stud to the substrate;
(g) placing the welding gun against the substrate and activating the gun to create a weld between the substrate and the stud; and
(h) removing the stud welding gun from the welded stud and discarding the ferrule.

11. The process of claim 10, further comprising the step of coating predetermined portions of the ferrule body with a binder, wherein the binder facilitates binding the flux to the ferrule body.

12. The process of claim 11, wherein the binder further includes polyvinyl alcohol.

13. The process of claim 10, wherein the flux is an agglomerated, granular, fusible mineral compound.

14. The process of claim 10, wherein the flux is operative to reduce the welding current required to create a drawn arc stud weld.

15. The process of claim 10, wherein the modified ferrule and modified flux are operative to enhance the aesthetic appearance of a weldment created by the process.

16. The process of claim 10, wherein the modified ferrule and modified flux are operative to enhance the fatigue resisting characteristics of a weldment created by the process.

17. The process of claim 10, wherein the modified ferrule and modified flux are operative to enhance the weld metal flow characteristics of a weldment created by the process.

18. The process of claim 10, wherein the substrate provided is galvanized.

19. The process of claim 18, further comprising the step of coating the inner surfaces of the ferrule body with an oxidizing agent, wherein the oxidizing agent is operative to oxidize the galvanized substrate and improve the drawn arc stud welding process to the galvanized substrate.

20. The process of claim 19, wherein the oxidizing agent further includes polyvinyl alcohol, iron oxide, copper oxide, or combinations thereof.
